(19) United States
(12) Patent Application Publication
(10) Pub. No.: US 2025/0116464 A1
(43) Pub. Date: Apr. 10, 2025

(54) HEAT EXCHANGER COMPRISING AT LEAST ONE LATERAL ENCASULATION PLATE, AIR CONDITIONING SYSTEM AND VEHICLE

(71) Applicant: LIEBHERR-AEROSPACE TOULOUSE SAS, Toulouse (FR)

(72) Inventors: Florian Bonnivard, Toulouse (FR); Arnaud RAMOUSSE, Toulouse (FR); Ricard DIDIER, Toulouse (FR)

(73) Assignee: LIEBHERR-AEROSPACE TOULOUSE SAS, Toulouse (FR)

(21) Appl. No.: 18/730,780

(22) PCT Filed: Dec. 22, 2022
(86) PCT No.: PCT/EP2022/087635

§ 371 Date: Jul. 21, 2024

(30) Foreign Application Priority Data
Jan. 27, 2022 (FR) FR2200723

(51) Int. Cl. F28D 9/00; B64D 13/08; F28D 21/00

(52) U.S. Cl. CPC F28D 9/0006; B64D 13/08; F28D 9/0062; F28D 2021/0021

(57) ABSTRACT

The invention relates to a plate heat exchanger (1) configured for a heat exchange between a first fluid flowing in a first pass and a second fluid flowing in a second pass, the fluids flowing between two external plates (2), comprising a plate exchanger block comprising a plurality of internal plates (12, 14) arranged substantially in parallel with each other, said internal plates being arranged substantially in parallel with the external plates (2),

characterized in that it comprises at least one lateral encapsulation plate (20) extending substantially orthogonally to said internal plates, each lateral encapsulation plate being fixed in contact with said external plates (2) so as to laterally close said second pass.

### TECHNICAL FIELD OF THE INVENTION

The invention relates to a heat exchanger. In particular, the invention relates to a heat exchanger with plates and fins, which can be used in an air-conditioning system, e.g. an airborne, rail-bound or surface vehicle.

The invention relates in particular to a plate heat exchanger, two different heat-transfer fluids flowing between said plates so as to cool or heat a first fluid by means of a second fluid, the two fluids being separated from each other by plates, in contact with which said heat exchange takes place.

### TECHNOLOGICAL BACKGROUND

Heat exchangers are used to make possible a heat transfer between at least two fluids, in particular in order to cool or heat one of the fluids by means of another fluid. Heat exchangers are used in numerous contexts, and in particular in air-conditioning systems for an airborne, rail-bound or surface vehicle, in which systems they make it possible in particular to regulate the temperature of the air conditioned by the air-conditioning system at different stages of the conditioning process.

Most heat exchangers currently used on board aircraft are formed by a generally rectangular heat exchange chamber which houses a stack of plates and fins (also referred to by the term “core” of plates or fins) which form stacked flow channels, for the hot pass and for the cold pass in alternation. Thus, the hot pass which supplies one face of the exchanger flows in the channels of the different layers and the cold pass which supplies one face of the exchanger flows in the channels interleaved between two channels of the hot pass.

This architecture makes it possible to interleave each hot channel between two cold channels over the whole length or height of the exchanger and thus to ensure heat exchanges between the two fluids.

Different configurations for the flow of the two fluids within this stack of plates and fins are possible. Cross flow heat exchangers are configured such that the hot circuit and the cold circuit are transverse to one another. Exchangers having more complex flow configurations are also available. These include, in particular, heat exchangers with counterflow hot and cold circuits, i.e. the hot and cold air streams go in parallel directions opposite to each other.

In these heat exchangers, some faces or portions, through which there is no inlet or outlet for the hot pass or for the cold pass, are formed of a succession of closing bars corresponding to the hot pass and to the cold pass. U.S. Pat. No. 3,613,782 proposes, for example, a counterflow heat exchanger having a Z-shaped or U-shaped configuration comprising such portions provided with closing bars.

Such a wall consisting of hot and cold closing bars (or strips) provides strong local rigidity. Under the effect of the mechanical and/or thermal stresses to which heat exchangers are subjected, in particular when they are integrated in atmospheric vehicles, such a local rigidity increases the fluid leakage risks.

Furthermore, IT UB20 160 428 describes a plate heat exchanger, each plate being provided with nesting and holding means between superimposed sheets, these means comprising, over at least part of two opposite edges of the sheet, flaps formed by folding or by applying added elements. It comprises additional linear connection profiles forming flanges for connection of the ducts supplying the fluids to the inlet sections and to the outlet sections for the primary and secondary fluids.

US 2021/199392 describes a heat exchanger with plates and fins in which closing bars are always provided on the third and fourth faces.

U.S. Pat. No. 5,823,247 describes a plate heat exchanger comprising a stack of mutually parallel plates between a first and second holding plate, in which openings are provided. The plates form chamber walls for inlet and outlet of the fluids.

The invention thus aims to propose a heat exchanger permitting these disadvantages to be overcome.

### Aims of the Invention

The invention aims to provide a heat exchanger having a very low fluid leakage risk.

The invention aims in particular to provide a heat exchanger having excellent structural cohesion which is stable over time.

The invention also aims to provide a heat exchanger with an excellent level of efficacy.

### Description of the Invention

To this end, the invention relates to a plate heat exchanger configured for a heat exchange between a first fluid flowing in a first pass and a second fluid flowing in a second pass, the fluids flowing between two external plates, comprising a plate exchanger block comprising a plurality of internal plates arranged substantially in parallel with each other, said internal plates being arranged substantially in parallel with the external plates,
characterized in that it comprises at least one lateral encapsulation plate extending substantially orthogonally to said internal plates, each lateral encapsulation plate being fixed in contact with said external plates so as to laterally close said second pass.

A heat exchanger in accordance with the invention thus permits the at least partial replacement of the closing bars closing one of the fluid passes of the heat exchanger. This makes it possible to limit the local rigidity associated with the presence of a succession of closing bars in a heat exchanger. This also makes it possible to achieve a uniform structure for the core.

Advantageously and in accordance with the invention, each lateral encapsulation plate is fixed, e.g. welded, to the external plates at their lateral ends, which allows each plate to be detached from the core. Therefore, none of the lateral encapsulation plates are fixed (or welded) to said internal plates.

A heat exchanger in accordance with the invention thus comprises a passage, referred to as pass of the first fluid, permitting the flow of a stream of the first fluid between a first inlet and a first outlet of said exchanger block.

A heat exchanger in accordance with the invention comprises a passage, referred to as pass of the second fluid, permitting the flow of a stream of the second fluid between a second inlet and a second outlet of said exchanger block.

Advantageously and in accordance with the invention, each lateral encapsulation plate has a main, rectangular, planar portion.

Advantageously and in accordance with the invention, each lateral encapsulation plate has at least one first longitudinal shoulder shaped to be able to form a band for an inlet and/or an outlet for said second fluid.

Advantageously and in accordance with the invention, each lateral encapsulation plate has at least one second longitudinal shoulder shaped to be able to extend in contact with a band for an inlet and/or an outlet for said first fluid.

Advantageously and in accordance with the invention, each lateral encapsulation plate extends facing a face of said plate exchanger block having no bars closing said second pass, said face being provided with bars closing said first pass.

Each lateral encapsulation plate can be positioned in contact, or out of contact, with the internal plates. Advantageously and in accordance with the invention, each lateral encapsulation plate is configured so as not to be in contact with the internal plates. As an alternative, according to another variant of a plate exchanger in accordance with the invention, each lateral encapsulation plate is configured to be in contact with the internal plates. This latter embodiment variant is particularly advantageous in terms of the mechanical aspect, in particular with respect to mechanical stresses or some mechanical forces.

A heat exchanger in accordance with the invention can have different configurations for the flow of the first fluid and of the second fluid within the exchanger block. It is possible to use an exchanger block in which the stream of the one and/or the other of the first or of the second heat-transfer fluid follows a U-shaped or even an S-shaped or Z-shaped course. Advantageously and in accordance with the invention, the heat exchanger in accordance with the invention is configured for a counterflow heat exchange between said first fluid flowing in the first pass and said second fluid flowing in the second pass. There is also nothing to prevent the provision of a heat exchanger having a portion within which the heat exchange is of the parallel flow type, i.e. the streams of the first fluid and of the second fluid go in parallel directions identical to each other.

Advantageously and in accordance with the invention, said first fluid flows between said internal plates in a main flow direction of said first fluid. Advantageously and in accordance with the invention, said second fluid flows between said internal plates in a main flow direction of said second fluid. Advantageously and in accordance with the invention, each lateral encapsulation plate is configured so as to extend in a plane in parallel with said main flow direction of said first fluid and/or with said main flow direction of said second fluid.

Advantageously and in accordance with the invention, said heat exchanger in accordance with the invention comprises two lateral encapsulation plates.

The second heat-transfer fluid corresponds for example to the heat-transfer fluid which is at a temperature lower than the temperature of the first fluid or vice versa. In other words, the first fluid can be called the “hot” fluid and the second fluid can be called the “cold” fluid.

Advantageously and in accordance with the invention, each fluid can be in liquid or gaseous form. In particular, the state of the first fluid can be identical to, or different from, the state of the second fluid. Advantageously and in accordance with the invention, the first fluid and the second fluid are in gaseous form.

Flow guides can be interleaved between the internal plates of the exchanger block. Each flow guide can have an undulating shape, the height of the undulations being substantially equal to the distance between internal plates. Thus each flow guide has a plurality of external regions and internal regions in surface contact with the inner face of the internal plates. Each flow guide can have a plurality of undulations so as to form a plurality of flow channels for the first fluid and for the second fluid in the exchanger block. Each flow guide can have a profile undulating regularly in a periodic shape, for example of the sinusoidal or notched type.

Each flow guide can be fixedly attached to the internal plates by a plurality of surface contacts. In particular, each flow guide can be fixedly attached to the internal plates e.g. by soldering or by welding.

The heat exchanger in accordance with the invention can be formed from at least one material chosen from metallic materials, composite materials, polymeric materials, ceramic materials, in particular graphite, glass. In particular, in one particularly advantageous embodiment of a heat exchanger in accordance with the invention, the plates are formed from a metallic material, in particular from at least one material chosen from the group formed by steels, copper, aluminum, metallic alloys (in particular super-alloys) and mixtures thereof.

The invention relates to an air-conditioning system comprising at least one heat exchanger in accordance with the invention. It can be a contactless counterflow exchanger or even an exchanger with a U-shaped or Z-shaped flow.

The invention relates to a vehicle, in particular an aircraft, comprising at least one air-conditioning system in accordance with the invention.

The invention also relates to a heat exchanger, an air-conditioning system and a vehicle comprising at least one such air-conditioning system, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic partial perspective view of a heat exchanger in accordance with the invention,

FIG. 2 is a schematic partial perspective view of a heat exchanger in accordance with the invention,

FIG. 3 is a schematic cross-sectional view of a heat exchanger in accordance with the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

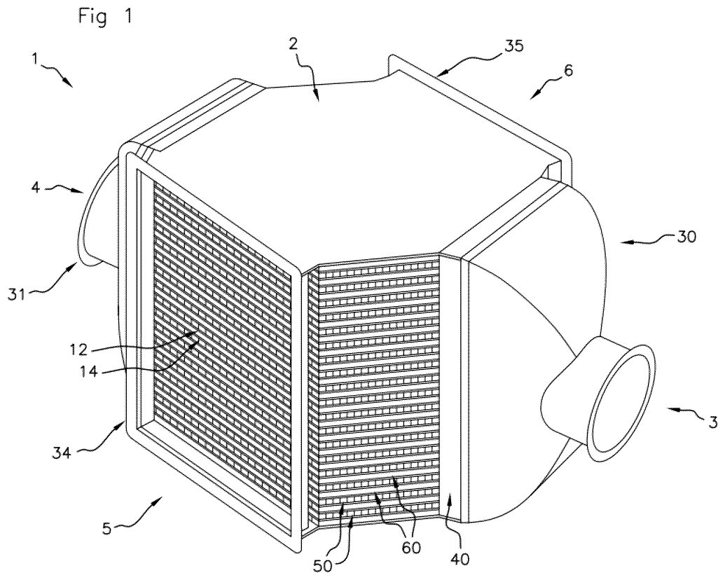

FIG. 1 schematically illustrates a plate heat exchanger 1 configured for a heat exchange between a first fluid flowing in a first pass and a second fluid flowing in a second pass. The heat exchanger 1 comprises two external plates 2, between which the plates are arranged.

The plate exchanger block comprises a stack of planar internal plates, between each of which flow guides in the form of undulated metal sheets are interleaved. A first and a second fluid flow in the spaces between the internal plates.

The internal plates are arranged in parallel with each other. The first fluid flows between a first inlet 3 and a first outlet 4. The second fluid flows between a second inlet 5 and a second outlet 6.

The heat exchanger 1 comprises two lateral encapsulation plates 20 each extending substantially orthogonally to the internal plates 12, 14. Each lateral encapsulation plate 20 is fixed in contact with the external plates 2 so as to close the second pass.

Each lateral encapsulation plate 20 is welded between the external plates 2 on the core-bands of the exchanger, which allows each plate to be detached from the core in contrast to the closing bars used in a heat exchanger in accordance with the prior art, none of the lateral encapsulation plates 20 being fixed (and thus in particular welded) to the internal plates.

The first fluid is for example the fluid referred to as “hot” and flows in the hot pass (first pass) whilst the second fluid is the fluid referred to as “cold” flowing in the cold pass (second pass).

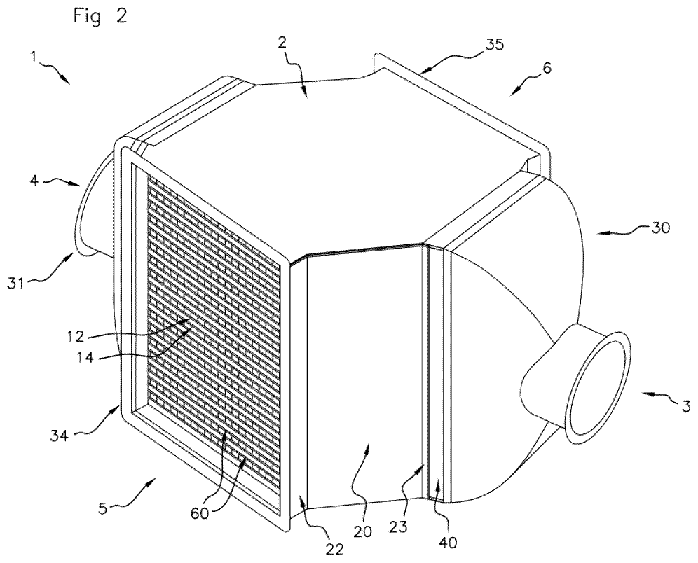

As can be seen in FIG. 2, each lateral encapsulation plate 20 has a main, rectangular, planar portion and two shoulders 22, 23 along mutually opposite edges of the main portion:
a first longitudinal shoulder 22 forms a band for an inlet and/or an outlet for said second fluid,
a second longitudinal shoulder 23 is shaped to be able to extend in contact with a core-band 40 for an inlet or an outlet for the first fluid.

The first shoulder 22 of the lateral encapsulation plate 20 forms a core-band at the inlet of the cold pass to which a frame or an inlet box for the cold fluid can be fixed.

Each lateral encapsulation plate 20 extends facing a face of the plate exchanger block having no bars closing the second pass but provided solely with bars 60 closing the first pass. As can be seen in FIG. 1, the second pass, in these portions, has layers 50 having no closing bars. In the illustrated embodiment, the lateral encapsulation plates thus make it possible to dispense with the closing bars referred to as “cold” from the faces or portions of the exchanger block through which there is no inlet or outlet for the hot pass or for the cold pass. The invention thus makes it possible to dispense with the walls consisting of closing bars (or strips) formed of a succession of closing bars corresponding to the hot and cold passes.

In the final position, after having been fixed, e.g. by welding, to the external plates 2, the lateral encapsulation plates 20 do not need to be in contact with the ends of the internal plates.

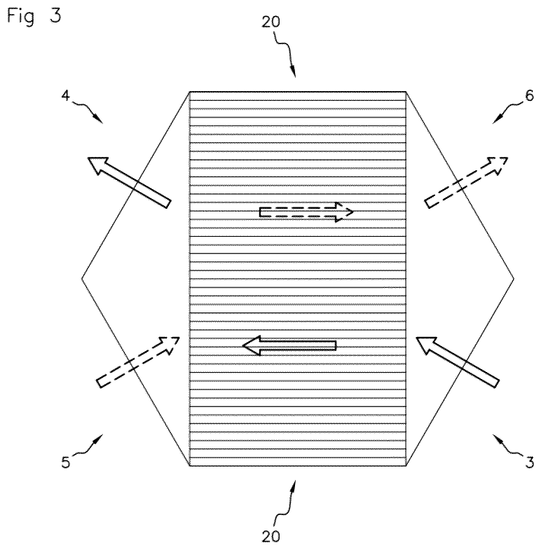

The heat exchanger shown in FIGS. 1 to 3 is a counterflow heat exchanger. As can be seen in FIG. 3 (longitudinal sectional view of the exchanger in a plane in parallel with the internal plates), a counterflow portion extends between the two encapsulation plates 20, the first and the second fluid each following a Z-shaped course. Any other type of configuration for the course of the fluids is, of course, also possible, e.g. a U-shaped circuit.

In the illustrated embodiment, the plate exchanger block is in the general shape of a right-angle prism with a hexagonal base and thus has eight main faces, two of these faces being formed by the two external plates 2 and another two of these faces being formed by the two lateral encapsulation plates 20.

In the illustrated embodiment, the first inlet 3 has an inlet mouth for the first fluid provided in an inlet box 30. Similarly, the first outlet 4 has an outlet mouth provided in an outlet box 31 for the first fluid exiting the exchanger block. Each mouth has just one (a single) orifice forming an inlet or outlet, an opening towards the plate exchanger block, and a solid peripheral wall between this orifice and this opening. Each orifice of each mouth can be connected to a duct for letting in or evacuating the first fluid.

In the illustrated embodiment, the boxes 30, 31 are welded to the core-bands 40 referred to as “hot” of the exchanger.

In the illustrated embodiment, an inlet frame 34 is fixed at the second inlet 5 and an outlet frame 35 is fixed at the second outlet 6.

A heat exchanger in accordance with the invention makes it possible to effectively eliminate the leakage risks in an exchanger block. A heat exchanger in accordance with the invention makes it possible to dispense with the welding of one of the two core-bands, thereby freeing two of the six corners of the core.

The invention is not limited to the embodiments described above. In particular, the lateral encapsulation plates, the closing bars, the core-bands and the manifolds can be of different shapes. The hot air flow circuits can, as already described, have shapes different from those shown.

1. A plate heat exchanger, configured for a heat exchange between a first fluid flowing in a first pass and a second fluid flowing in a second pass, the fluids flowing between two external plates, the plate heat exchanger comprising:
a plate exchanger block comprising a plurality of internal plates arranged substantially in parallel with each other, said internal plates being arranged substantially in parallel with the external plates, said first fluid and said second fluid flowing in spaces between said internal plates, characterized in that it comprises at least one lateral encapsulation plate extending substantially orthogonally to said internal plates, each lateral encapsulation plate being fixed in contact with said external plates so as to laterally close said second pass,
each lateral encapsulation plate extending facing a face of said plate exchanger block having no bars closing said second pass, said face being provided with bars closing said first pass.

2. The plate heat exchanger as claimed in claim 1, wherein each lateral encapsulation plate has a main, rectangular, planar portion.

3. The plate heat exchanger as claimed in claim 1, wherein each lateral encapsulation plate has at least one first longitudinal shoulder shaped to be able to form a band for an inlet for said second fluid and/or an outlet for said second fluid.

4. The plate heat exchanger as claimed in claim 1, wherein each lateral encapsulation plate has at least one second longitudinal shoulder shaped to be able to extend in contact with a band for an inlet and/or an outlet for said first fluid.

5. The plate heat exchanger as claimed in claim 1, wherein each lateral encapsulation plate is configured so as not to be in contact with the internal plates.

6. The plate heat exchanger as claimed in claim 1, wherein the plate heat exchanger is configured for a counterflow heat exchange between said first fluid flowing in the first pass and said second fluid flowing in the second pass.

7. The plate heat exchanger as claimed in claim 1, further comprising two lateral encapsulation plates.

8. An air-conditioning comprising at least one heat exchanger comprising:
a plate exchanger block comprising a plurality of internal plates arranged substantially in parallel with each other, said internal plates being arranged substantially in parallel with the external plates, said first fluid and said second fluid flowing in spaces between said internal plates, characterized in that it comprises at least one lateral encapsulation plate extending substantially orthogonally to said internal plates, each lateral encapsulation plate being fixed in contact with said external plates so as to laterally close said second pass,
each lateral encapsulation plate extending facing a face of said plate exchanger block having no bars closing said second pass, said face being provided with bars closing said first pass.

9. A vehicle—in particular an aircraft—comprising at least one air-conditioning system comprising at least one heat exchanger comprising:
a plate exchanger block comprising a plurality of internal plates arranged substantially in parallel with each other, said internal plates being arranged substantially in parallel with the external plates, said first fluid and said second fluid flowing in spaces between said internal plates, characterized in that it comprises at least one lateral encapsulation plate extending substantially orthogonally to said internal plates, each lateral encapsulation plate being fixed in contact with said external plates so as to laterally close said second pass,
each lateral encapsulation plate extending facing a face of said plate exchanger block having no bars closing said second pass, said face being provided with bars closing said first pass.
